(19) United States
(12) Patent Application Publication
(10) Pub. No.: US 2024/0169207 A1
(43) Pub. Date: May 23, 2024

(54) MACHINE LEARNING PIPELINE FOR DETERMINING DUPLICATE CRASH REPORTS IN SOFTWARE DEVELOPMENT

(71) Applicant: SAP SE, Walldorf (DE)

(72) Inventors: Chao Liu, Xi'an (CN); Yang Xu, Xi'an (CN); Qiao-Luan Xie, Xi'an (CN); Yong Li, Xi'an (CN); Hyun Deok Choi, Seoul (KR)

(21) Appl. No.: 17/985,995

(22) Filed: Nov. 14, 2022

(51) Int. Cl. G06N 3/08; G06F 11/36; G06N 3/04

(52) U.S. Cl. CPC G06N 3/088; G06F 11/3692; G06N 3/0454

(57) ABSTRACT

Methods, systems, and computer-readable storage media for receiving a set of crash reports, determining a set of trace vectors by processing a set of stack traces through a first DL model, each trace vector in the set of trace vectors being a multi-dimensional vector representation of a stack trace of a respective crash report provided from the set of stack traces, generating a set of feature vectors by processing the set of trace vectors through a second DL model, each feature vector being a multi-dimensional vector representation of a stack trace of a respective crash report, and clustering each crash report in the set of crash reports into a group of a set of groups based on comparing feature vectors of respective crash reports, each group representative of a root cause resulting in respective crashes of the software system represented in one or more crash reports.

### BACKGROUND

Software development includes a process of debugging, in which errors in source code are identified and removed. Modern software systems have increasingly large and complicated source code, which results in an increasing number of bugs that are to be identified and removed. To facilitate debugging, a crash reporting system is deployed to automatically gather crash reports from testing, delivery, and end users (customers) that are generated in response to crashing of the software. In general, a software crash can be described as a condition, in which the software stops functioning properly.

To help developers reduce debugging efforts, it is important to automatically organize duplicate crash reports into groups, each group (cluster) representing multiple, duplicate crash reports. Typically, duplicate crash report detection includes extracting a stack trace from each crash report, determining similarities between pairs of stack traces, and grouping pairs of stack traces into the same group, if the similarity exceeds a similarity threshold. However, computing similarity between stack traces is a difficult task. For example, in typical cases, duplicate crash reports can include stack traces that only have the some overlap in functions. In more difficult cases, duplicate crash reports can include stack traces that have little overlap in functions. That is, it can occur that crash reports that are relatively dissimilar, as a whole, are actually duplicates.

In some traditional approaches, duplicate detection can utilize the position of frame, trace alignment, and/or edit distance to compute the similarity between stack traces. However, this limits throughput and increases consumption of technical resources (e.g., processors, memory) for computation, particularly for large-scale crash bucketing tasks. In order to improve throughput, an example strategy can include speeding up the similarity measurement of stack traces by, for example, aligning the stack traces. However, stack trace alignment itself consumes time and resources, which limit throughput.

### SUMMARY

Implementations of the present disclosure are directed to a duplicate crash report detection system to identify duplicate crash reports from stack traces. More particularly, implementations of the present disclosure are directed to a duplicate crash report detection system that includes a deep learning (DL) pipeline to identify duplicate crash reports based on feature vectors determined from stack traces.

In some implementations, actions include receiving a set of crash reports, each crash report provided as a computer-readable file, determining a set of trace vectors by processing a set of stack traces through a first DL model, each trace vector in the set of trace vectors being a multi-dimensional vector representation of a stack trace of a respective crash report provided from the set of stack traces, generating a set of feature vectors by processing the set of trace vectors through a second DL model, each feature vector being a multi-dimensional vector representation of a stack trace of a respective crash report, and clustering each crash report in the set of crash reports into a group of a set of groups based on comparing feature vectors of respective crash reports, each group representative of a root cause resulting in respective crashes of the software system represented in one or more crash reports. Other implementations of this aspect include corresponding systems, apparatus, and computer programs, configured to perform the actions of the methods, encoded on computer storage devices.

These and other implementations can each optionally include one or more of the following features: actions further include pre-processing each crash report in the set of crash report to extract a respective stack trace that is included in the set of stack traces; processing the set of stack traces through the first DL model include, for each stack trace and for each frame in a set of frames of the stack trace, segmenting a frame into a set of sub-frames, determining a sub-frame representation for each sub-frame in the set of sub-frames, and combining the sub-frame representations to provide a trace vector for the frame; generating the set of feature vectors by processing the set of trace vectors through the second DL model includes providing each trace vector as input to the second DL model and receiving a respective feature vector as output of the second DL model; the second DL model is trained using a circle loss to minimize distances between anchor samples and positive samples and maximize distances between the anchor samples and negative samples, and a softmax loss based on predictions of a large-margin softmax layer; wherein the second DL model includes bidirectional long short-term memory (Bi-LSTM) layers, two fully-connected layers (linear), and a rectified linear unit (ReLU) layer; and at least one group is used to debug the software system with respect to a respective root cause.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts a conceptual architecture of duplicate crash report detection system in accordance with implementations of the present disclosure.

FIG. 3A depicts an example crash report.

FIG. 3B depicts an example stack trace.

FIG. 3C depicts example trace vectors.

FIG. 4 depicts an example deep metric model in accordance with implementations of the present disclosure.

FIG. 5 depicts an example process that can be executed in accordance with implementations of the present disclosure.

FIG. 6 is a schematic illustration of example computer systems that can be used to execute implementations of the present disclosure.

Like reference symbols in the various drawings indicate like elements.

### DETAILED DESCRIPTION

Implementations of the present disclosure are directed to a duplicate crash report detection system to identify duplicate crash reports from stack traces. More particularly, implementations of the present disclosure are directed to a duplicate crash report detection system that includes a deep learning (DL) pipeline to identify duplicate crash reports based on feature vectors determined from stack traces. Implementations can include actions of receiving a set of crash reports, each crash report provided as a computer-readable file, determining a set of trace vectors by processing a set of stack traces through a first DL model, each trace vector in the set of trace vectors being a multi-dimensional vector representation of a stack trace of a respective crash report provided from the set of stack traces, generating a set of feature vectors by processing the set of trace vectors through a second DL model, each feature vector being a multi-dimensional vector representation of a stack trace of a respective crash report, and clustering each crash report in the set of crash reports into a group of a set of groups based on comparing feature vectors of respective crash reports, each group representative of a root cause resulting in respective crashes of the software system represented in one or more crash reports.

As used herein, duplicate crash reports indicate crash reports that are generated in response to the same root cause. That is, crash reports that are duplicates do not need to be the same crash report in and of itself. For example, a first device can encounter a first crash that results from a root cause and, in response, a first crash report is generated. A second device can encounter a second crash that results from the root cause and, in response, a second crash report is generated. The first crash report and the second crash report, while being different crash reports, can be identified as duplicates, because they were generated in response to the root cause (i.e., the same root cause). As another example, the first device can encounter a third crash that results from the root cause and, in response, a third crash report is generated. The first crash report and the third crash report, while being different crash reports, can be identified as duplicates, because they were generated in response to the root cause (i.e., the same root cause).

To provide further context for implementations of the present disclosure, and as introduced above, software development includes a process of debugging, in which errors in source code are identified and removed. Modern software systems have increasingly large and complicated source code, which results in an increasing number of bugs that are to be identified and removed. To facilitate debugging, a crash reporting system is deployed to automatically gather crash reports from testing, delivery, and end users (customers) that are generated in response to crashing of the software. In general, a software crash can be described as a condition, in which the software stops functioning properly.

Typically, crash reports contain information on the environment (e.g., device, operating system), system status, stack trace, and execution. In some examples, a stack trace can be described as a control flow of the software. In a crash report, a stack trace represents a control flow leading up to a crash. A control flow can include an order of functions that were executed leading up to a crash. A stack trace alone can provide sufficient information for developers to know where to look for the root cause of a crash. However, manually finding the root cause of a crash can be difficult. For example, root cause analysis can require deep knowledge and understanding of the source code. Moreover, as the number of crashes increases, manual analysis of the crashes becomes unpractical.

To help developers reduce debugging efforts, it is important to automatically organize duplicate crash reports into groups, each group (cluster) representing multiple, duplicate crash reports. A duplicate crash report can be generally described as a crash report that results from the same root cause as another crash report (i.e., multiple crash reports are generated for the same root cause). This task is referred to as duplicate crash report detection, crash report bucketing, or crash report deduplication. By grouping crash reports based on duplicates, developers can more quickly and efficiently address and resolve issues in software.

Typically, duplicate crash report detection includes extracting a stack trace from each crash report, determining similarities between pairs of stack traces, and grouping pairs of stack traces into the same group, if the similarity exceeds a similarity threshold. In some examples, a group can include multiple crash reports (e.g., duplicate crash reports). In some examples, a group can include a single crash report (e.g., the crash report is not associated with a duplicate). However, computing similarity between stack traces is a difficult task. For example, in typical cases, duplicate crash reports can include stack traces that only have the some overlap in functions. In more difficult cases, duplicate crash reports can include stack traces that have little overlap in functions. That is, it can occur that crash reports that are relatively dissimilar, as a whole, are actually duplicates in that they result from the same root cause.

In some traditional approaches, duplicate detection can utilize the position of frame, trace alignment, and/or edit distance to compute the similarity between stack traces. For example, some approaches compute every frame pair edit distance as a frame pair similarity and aggregate the frame pairs similarities based on weights (e.g., determined by text frequency and inverse document frequency (TF-IDF)). However, this limits throughput and increases consumption of technical resources (e.g., processors, memory) for computation, particularly for large-scale crash bucketing tasks. In order to improve throughput, an example strategy can include speeding up the similarity measurement of stack traces by, for example, aligning the stack traces. However, stack trace alignment itself consumes time and resources, which limit throughput.

In view of the above context, implementations of the present disclosure provide a duplicate crash report detection system that includes a DL pipeline to identify duplicate crash reports based on feature vectors determined from stack traces. In some implementations, the duplicate crash report detection system of the present disclosure includes mapping stack traces of crash reports to respective feature vectors and grouping the crash reports into buckets (also referred to herein as groups and/or clusters) based on the feature vectors. In some examples, the duplicate crash report detection system includes a frame tokenization DL model, referred to herein as frame2vec, that extracts frame representations in stack traces based on frame segmentation. In some examples, the duplicate crash report detection system includes a deep metric model (a DL model) that maps sequential stack trace representations into feature vectors that can be used to determine similarity between pairs of crash reports. In some examples, the duplicate crash report detection system includes a clustering algorithm that is used to group crash reports (based on respective feature vectors) into buckets. As described in further detail herein, the duplicate crash report detection system of the present disclosure provides time- and resource-efficient detection of duplicate crash reports even in instances of large-scale crash report bucketing.

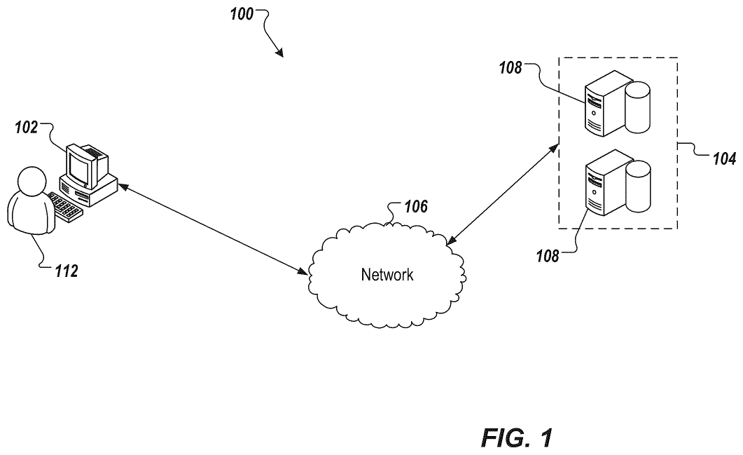

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In some implementations, and as noted above, the server system 104 can host a duplicate crash report detection system of the present disclosure. In some examples, the server system 104 receives a set of crash reports that is processed using the duplicate crash report detection system to time- and resource-efficiently identify any duplicate crash reports in the set of crash reports. In some examples, crash reports can be received from one or more sources. Example sources can include, without limitation, users of software, for which the crash reports are generated, and a developer of the software.

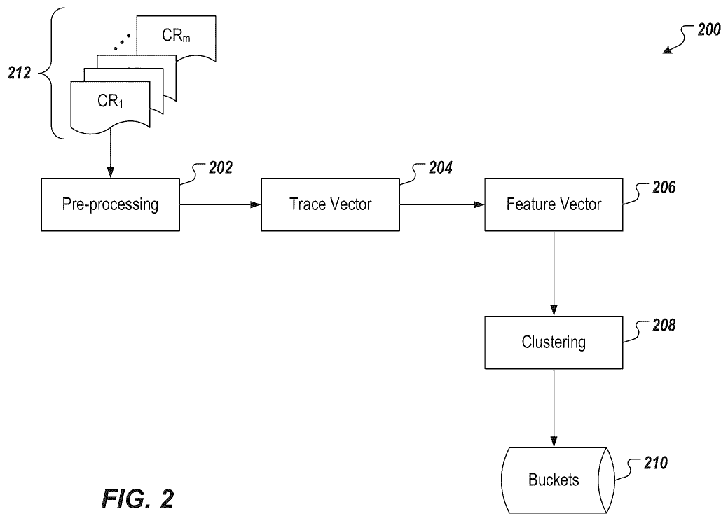

FIG. 2 depicts a conceptual architecture of duplicate crash report detection system 200 in accordance with implementations of the present disclosure. In the example of FIG. 2, the duplicate crash report detection system 200 includes a pre-processing module 202, a trace vector module 204, a feature vector module 206, a clustering module 208, and a crash report bucket store 210. As described in further detail herein, the duplicate crash report detection system 200 receives a set of crash reports 212 (e.g., CR₁, . . . , CRₘ) and processes the set of crash reports 212 to group duplicate crash reports into respective buckets. That is, and as described in further detail herein, pairs of crash reports that are determined to be duplicate crash reports are clustered into the same bucket. In this manner, each bucket (group, cluster) includes a respective sub-set of crash reports of the set of crash reports 202.

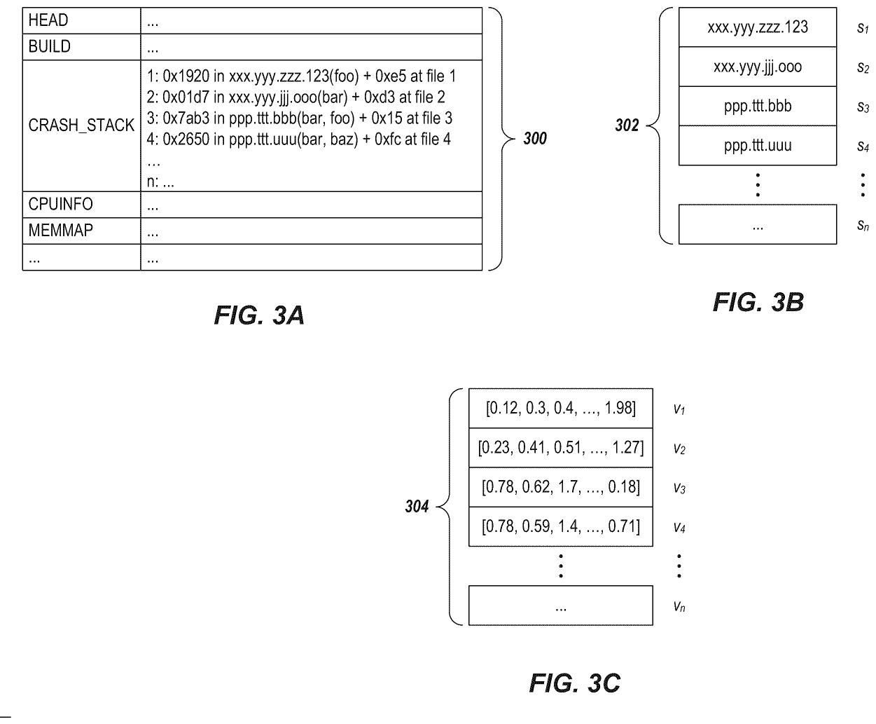

FIG. 3A depicts an example crash report 300. As depicted in FIG. 3A, the example crash report 300, and crash reports generally, contains a multitude of information representative of a respective crash of a software system. In some examples, crash reports, such as the example crash report 300 of FIG. 3, include information describing a state of the software at the time of a crash to assist developers in eventually fixing a bug that resulted in the crash. In some examples, [HEADER] information includes general information such as the process identifier (PID) of the crashing process and the time of crash, and other information includes [BUILD] information, [CRASH_STACK] information, [CPUINFO] information, and [MEMMAP] information. The content of the call stack is provided in the [CRASH_STACK] as a stack trace, which can also be referred to as an exception.

Referring again to FIG. 2, the pre-processing module 202 extracts stack traces from respective crash reports. In some examples, pre-processing includes removal of irrelevant information (e.g., offset address, file name), such that only function names remain. FIG. 3B depicts an example stack trace 302 (e.g., STᵢ={s₁, . . . , sₙ}ᵢ, where s indicates a respective frame in the stack trace, and i indicates the i^{th} crash report in the set of crash reports (where i=1, . . . m) provided from the example crash report 300 of FIG. 3A through pre-processing. Pre-processing is performed for each crash report in the set of crash reports 212, such that a set of stack traces (S) is provided (e.g., S={ST₁, . . . , STₘ}).

In accordance with implementations of the present disclosure, the trace vector module 204 processes each stack trace in the set of stack traces to determine a sequential trace representation provided as a trace vector for a respective stack trace. In some examples, the trace vector module 204 executes a DL model (e.g., frame2vec, referenced herein) to extract a frame representation for each frame based on aggregating sub-frame representations, and provides a respective trace vector by aggregating the frame representations. FIG. 3C depicts an example sequential trace representation 304 to provide a trace vector (e.g., Vᵢ={v₁, . . . , vₙ}ᵢ) from the example stack trace 302 of FIG. 3B. In some examples, each frame representation is provided as a multi-dimensional vector (v).

In further detail, in providing a trace vector, each frame is divided into sub-frames and a sub-frame representation (multi-dimensional vector) is provided for each sub-frame. The sub-frame representations are combined to provide a trace vector as a frame representation for the respective frame. This tokenization technique enables a reduction in a number of tokens that are stored in a token dictionary, thereby reducing memory. Further, this tokenization technique enhances a quality of the trace vectors because the DL model (frame2vec) preserves the semantic similarity of frames.

By way of non-limiting example, a first frame com.company.Class1. method1 and a second frame com.company.Class1.method2 represent two different functions in a stack trace. In this example, sub-frames of the first frame include com, company, Class1, and method1, and sub-frames of the second frame include com, company, Class1, and method2. In this example, the first frame and the second frame have the same prefix (i.e., com.company.Class1). In view of this, their respective frame representations should be similar (but not same).

In some examples, the following formulation can be used to denote the DL model (frame2vec):

vᵢ=Frame2Vec(sᵢ)

where vᵢ is the i^{th} frame representation. As indicated above, the sequential stack trace frames STᵢ={s₁, s₂, . . . , sₙ}ᵢ can be denoted by the trace vectors Vᵢ={v₁, . . . , vₙ}ᵢ. In some examples, to ensure that the trace vectors are suitable for stack traces, skip-gram negative sampling is used to optimize the DL model (frame2vec).

Referring again to FIG. 2, feature vector module 206 processes the trace vectors through a DL model (deep metric model) to provide a feature vector representative of a stack trace of a respective crash report. More particularly, for each stack trace, the DL model maps the trace vector (sequential stack frame representation) into a feature vector. In some examples, the DL model is provided as a neural network that maps the trace vectors into feature vectors. In some examples, circle loss and large-margin softmax are used during training to train the DL model to maximize the compactness of features of duplicate pairs (anchor sample and positive sample) and the separability of features of non-duplicate pairs (anchor sample and negative sample).

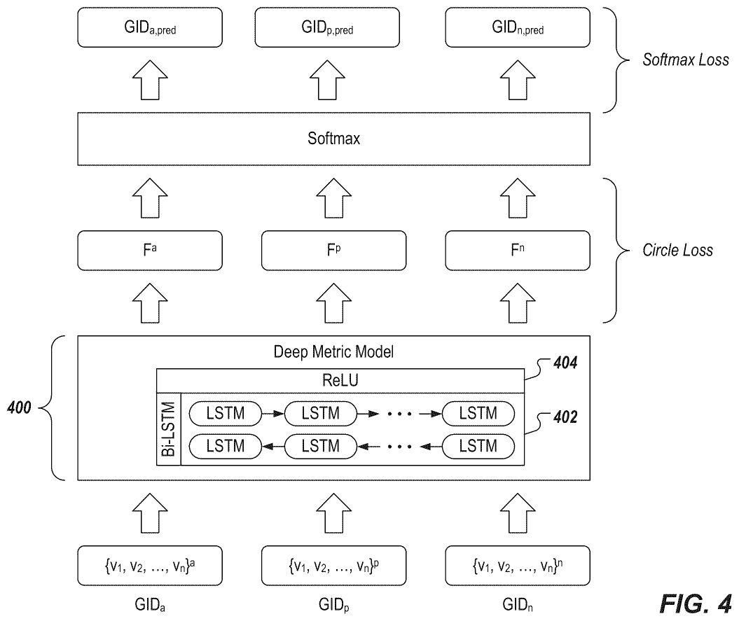

FIG. 4 depicts an example architecture of a deep metric model 400 in accordance with implementations of the present disclosure. In the example of FIG. 4, the deep metric model 400 includes bidirectional long short-term memory (Bi-LSTM) layers 402, two fully-connected layers (linear), and a rectified linear unit (ReLU) 404. In some examples, to map the trace vectors V, the Bi-LSTM layer 402 handles the sequential data (e.g., for Vᵢ, the sequence {v₁, . . . , vₙ}ᵢ). This can be formulated as:

F_{bilstm}_{ᵢ}=biLSTM(Vᵢ)

In some examples, two fully-connected layers and ReLU activation (of the ReLU layer 404) are stacked on the Bi-LSTM layer 402 for mapping trace vectors (V₁, . . . , Vₘ) into feature vectors (F₁, . . . , Fₘ). This can be formulated as:

Fᵢ=Linear(ReLU(Linear(F_{bilstm}(Vᵢ))))

FIG. 4 represents a training phase of the deep metric model 400, in which circle loss and large-margin softmax are combined to maximize the compactness (separability) of duplicate (non-duplicated) feature vectors of crash reports. In some examples, training data can include an anchor sample (a), a positive sample (p), and a negative sample (n), each associated with a respective group identifier (GID). Here, the samples include respective trace vectors, where the anchor trace vector and the positive trace vector are duplicates of one another, and the anchor trace vector and the negative trace vector are non-duplicates. In some examples, the GID can be considered a label that indicates a group (bucket) that the respective sample is assigned to. For example, GIDₐ can be the same as GIDₚ and can be different from GIDₙ.

In accordance with implementations of the present disclosure, the deep metric model 400 is trained based on predicted GIDs for the anchor, positive, and negative samples, respectively (e.g., GID_{a,pred}, GID_{p,pred}, GID_{n,pred}). More particularly, during training, a total loss ( [symbol] ) is determined based on a circle loss ( [symbol] _{circle}) and a softmax loss ( [symbol] _{l_softmax}), and parameters of the deep metric model 400 are adjusted between training iterations (e.g., using back-propagation). In some examples, iterations of training are executed until the total loss is minimized. The following example relationship can be provided:

[symbol]

= [symbol] _{circle}+ [symbol] _{l_softmax}

In further detail, the circle loss is determined based on an anchor feature vector (F^{a}), a positive feature vector (F^{p}), and a negative feature vector (Fⁿ) output by the deep metric model 400 for the respective trace vectors during training. In some examples, the circle loss is determined based on a first distance between the anchor feature vector and the positive feature vector, and a second distance between the anchor feature vector and the negative feature vector. In some examples, the first distance and the second distance can each be determined as a cosine distance. During training, the first distance is minimized, while the second distance is maximized. The circle loss can be represented as:

[symbol]

_{circle}(α, cos(F^{a},F^{p/n}))

where cos indicates the cosine distance, F^{a/p/n} denotes the feature vectors of anchor/positive/negative samples, and α is a margin that is enforced between positive and negative pairs.

In some examples, the softmax loss can be represented as:

[symbol]

_{l_softmax}(Ĝ^{a/p/n},G^{a/p/n})

where Ĝ is the predicted GID and G indicates the actual GID.

During inference, the (trained) deep metric model is used to provide a feature vector for each crash report in the set of crash reports. For example, each trace vector in the set of trace vectors V₁, . . . , Vₘ correspond to a respective crash report in the set of crash reports. Each trace vector is provided as input to the deep metric model (e.g., executed by the feature vector module 206 of FIG. 2), which provides a set of feature vectors F₁, . . . , Fₘ, each feature vector corresponding to a respective trace vector and thus, a respective crash report.

In accordance with implementations of the present disclosure, dis-/similarity between feature vectors can represent dis-/similarity between. That is the feature vectors of duplicate crash reports are similar to one another and feature vectors of non-duplicate crash reports are dissimilar to one another. Referring again to FIG. 2, the clustering module 208 groups feature vectors, and thus their respective crash reports into buckets, each bucket representing one or more crashes resulting from a (same) root cause. In some implementations, for each unique pair of feature vectors in the set of feature vectors, the clustering algorithm determines a similarity score. In some examples, the similarity score is calculated as a cosine distance between feature vectors in a pair of feature vectors. In some examples, if the similarity score exceeds a threshold similarity score, the crash reports corresponding to the feature vectors are included in the same bucket. In some examples, if the similarity score does not exceed the threshold similarity score, the crash reports corresponding to the feature vectors are not included in the same bucket.

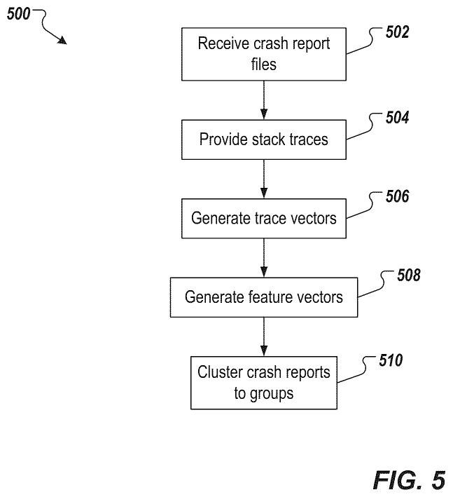

FIG. 5 depicts an example process 500 that can be executed in accordance with implementations of the present disclosure. In some examples, the example process 500 is provided using one or more computer-executable programs executed by one or more computing devices.

A set of crash reports is received (502). For example, and as described herein, the duplicate crash report detection system 200 of FIG. 2 receives the set of crash reports 212. In some examples, each crash report is provided as a computer-readable file. In some examples, each crash report is provided from a computing device executing a software system that experienced a crash of the software system. A set of stack traces is provided (504). For example, and as described herein, each crash report is pre-processed by the pre-processing module 202 to extract a respective stack trace that is included in the set of stack traces.

A set of trace vectors is generated (506). For example, and as described herein, each stack trace in the set of stack traces is processed through a DL model, frame2vec, by the trace vector module 204. In some examples, each trace vector in the set of trace vectors is a multi-dimensional vector representation of a stack trace of a respective crash report provided from the set of stack traces. In some examples, processing the set of stack traces through the DL model includes, for each stack trace and for each frame in a set of frames of the stack trace, segmenting a frame into a set of sub-frames, determining a sub-frame representation for each sub-frame in the set of sub-frames, and combining the sub-frame representations to provide a trace vector for the frame.

A set of feature vectors is generated (508). For example, and as described herein, each trace vector in the set of trace vectors is processed through a DL model, deep metric model, by the feature vector module 206. In some examples, the second DL model is trained using a circle loss to minimize distances between anchor samples and positive samples and maximize distances between the anchor samples and negative samples, and a softmax loss based on predictions of a large-margin softmax layer. In some examples, the second DL model includes bidirectional long short-term memory (Bi-LSTM) layers, two fully-connected layers (linear), and a ReLU.

Crash reports of the set of crash reports are clustered into a set of groups (510). For example, and as described herein, the clustering module 208 groups feature vectors, and thus their respective crash reports into buckets, each bucket representing one or more crashes resulting from a (same) root cause. In some implementations, for each unique pair of feature vectors in the set of feature vectors, the clustering algorithm determines a similarity score. In some examples, the similarity score is calculated as a cosine distance between feature vectors in a pair of feature vectors. In some examples, if the similarity score exceeds a threshold similarity score, the crash reports corresponding to the feature vectors are included in the same bucket. In some examples, if the similarity score does not exceed the threshold similarity score, the crash reports corresponding to the feature vectors are not included in the same bucket.

In accordance with implementations of the present disclosure, at least one group is used to debug the software system with respect to a respective root cause. For example, a developer can use one or more crash reports of a group to determine the root cause of the crashes represented by the group and can modify source code of the software system to resolve the root cause. In some examples, modification of the source code can be pushed to one or more devices in an updated to the software system.

As described herein, implementations of the present disclosure achieve one or more technical advantages and provides technical improvements of existing technological systems for detecting duplicate crash reports. Advantages and improvements achieved by implementations of the present disclosure are highlighted in a validation experiment that compares the duplicate crash report detection system of the present disclosure to other systems.

In further detail, a set of traditional duplicate crash report detection systems were identified for comparison to that of the present disclosure and the same hierarchical clustering algorithm was used to group crashes into buckets based on the respective similarity detection approach. For the validation experiment, a crash report data set was defined an included approximately 11,000 crash reports generated from internal testing of a software system. The crash report data set was split based on time to define a training set, a validation set, and a testing set. In the validation experiment, a split ratio of 20:1:5 was used. Table 1 shows the breakdown of splitting the crash report data set into the training set, the validation set, and the test set.

TABLE 1
Data Set Split

| Measure | Training | Validation | Testing |
|---|---|---|---|
| Groups | 6607 | 460 | 2234 |
| Reports | 7767 | 534 | 2910 |

To evaluate clustering performance, metrics of Purity, InversePurity, and F-measure were used, which are commonly used for evaluating clustering performance. Before computing these metrics, the Precision and Recall for each bucket were determined based on the following example relationships:

$$Precision ( {G}_{i} , {C}_{j} ) = \frac{\vert {G}_{i} ⋂ {C}_{j} \vert}{\vert {C}_{j} \vert}$$

$$Recall ( {G}_{i} , {C}_{j} ) = \frac{\vert {G}_{i} ⋂ {C}_{j} \vert}{\vert {G}_{i} \vert}$$

where Gᵢ indicates i^{th} actual group and Cⱼ means j^{th} cluster. The Purity, InversePurity, and F-measure were determined based on the following example relationships:

$$Purity = {\sum }_{j} \frac{\vert {C}_{j} \vert}{N} {max}_{i} \{ Precision ( {G}_{i} , {C}_{j} ) \}$$

$$InversePurity = {\sum }_{i} \frac{\vert {G}_{i} \vert}{N} {max}_{j} \{ Recall ( {G}_{i} , {C}_{j} ) \}$$

$$F - measure = {\sum }_{i} \frac{\vert {G}_{i} \vert}{N} {max}_{j} \{ F ( {G}_{i} , {C}_{j} ) \}$$

$$F ( {G}_{i} , {C}_{j} ) = \frac{2 * Precision ( {G}_{i} , {C}_{j} ) * Recall ( {G}_{i} , {C}_{j} )}{Precision ( {G}_{i} , {C}_{j} ) + Recall ( {G}_{i} , {C}_{j} )}$$

where N is the total number of testing samples.

For training a first sub-set of the existing technological systems, the training set was used to count the required information (e.g., using TF-IDF) and the hyperopt library was used to find the optimal parameters (which include the threshold for clustering) based on the validation set. For a second sub-set of the existing technological systems, an Adam optimizer was used with a learning rate of 1e−4, and other parameters are set as default configurations.

For training the duplicate crash report detection system of the present disclosure, the frame2vec model is trained first and the deep metric model is optimized using the (trained) frame2vec model. The detailed configurations of frame2vec and deep metric model are summarized in Table 2, where lr denotes the learning rate.

TABLE 2
Training Configuration

| Model | Network | Optimizing |
|---|---|---|
| frame2vec | Dimension of frame | Adam optimizer |
| | representation is 768. | lr = 1e−4 |
| | Number of negative | Epoch = 100, |
| | samples is 20. | Batchsize = 2048 |
| deep metric | Normalization layer | Adam optimizer |
| model | 2-layers Bi-LSTM | Cyclical lr = (1e−4, |
| | with 512 hidden. | 5e−4) Epoch = 1000, |
| | Linear size is 1024. | Batchsize = 512 |
| | ReLU activation | α = 0.4 |

Each of the duplicate crash report detection systems was executed using a workstation with Intel® Xeon® Platinum 8260 CPU @ 2.40 GHz, 156-GB RAM, and the operating system was SUSE Linux Enterprise Server 15 SP1. In addition, to avoid the influence of noise (e.g., background applications), every compared system was executed on a rebooted machine.

To assess precision, experiments were executed five times for each system and the average Purity, InversePurity, and F-measure were determined as the final results. Experiment results are summarized in Table 3.

TABLE 3
Experiment Results for Precision

| | | Inverse | |
|---|---|---|---|
| System | Purity | Purity | F-measure |
| Traditional System 1 | 91.50 | 81.53 | 81.21 |
| Traditional System 2 | 94.34 | 81.57 | 82.59 |
| Traditional System 3 | 94.02 | 81.11 | 81.74 |
| Traditional System 4 | 94.12 | 81.98 | 81.74 |
| Traditional System 5 | 93.22 | 82.30 | 81.38 |
| Traditional System 6 | 92.14 | 82.01 | 81.45 |
| Traditional System 7 | 89.33 | 81.61 | 80.01 |
| Present Disclosure | 94.23 | 83.84 | 83.73 |

From observing the Purity values based on crash report data set, four systems achieved 94-95%, including the duplicate crash report detection system of the present disclosure, the peak value being 94.34%. From observing the InversePurity scores, the duplicate crash report detection system of the present disclosure had the best performance with few being in 82-84%. The duplicate crash report detection system of the present disclosure achieves a high InversePurity value because similar frames will have similar frame representations. For F-measure score, the duplicate crash report detection system of the present disclosure had the best performance. The experimental results demonstrate that the duplicate crash report detection system of the present disclosure can achieve better precision performance than the others, balancing Purity and InversePurity.

With regard to speed, as is known, a high throughput crash bucketing system is important for large-scale crash bucketing. Intuitively, the feature-based similarity measurement could speed up the crash bucketing task. To validate this, the average clustering time all systems was determined for the five experiments. The performance results are summarized in Table 4.

TABLE 4
Experiment Results for Speed

| System | Avg. Time (minutes) |
|---|---|
| Traditional System 1 | 0.35 |
| Traditional System 2 | 111.0 |
| Traditional System 3 | 21.5 |
| Traditional System 4 | 25.1 |
| Traditional System 5 | 39.3 |
| Traditional System 6 | 6.0 |
| Traditional System 7 | 8.3 |
| Present Disclosure | 3.2 |

The results of Table 4 show that the duplicate crash report detection system of the present disclosure is the second fastest, grouping 2,910 crash reports in 3.2 minutes. While one system is faster, at 0.35 minutes, that system is one of the worst performing systems with respect to precision (see Table 3). Consequently, the experimental results illustrate that the duplicate crash report detection system of the present disclosure can support large-scale duplication identification with improved precision over traditional systems.

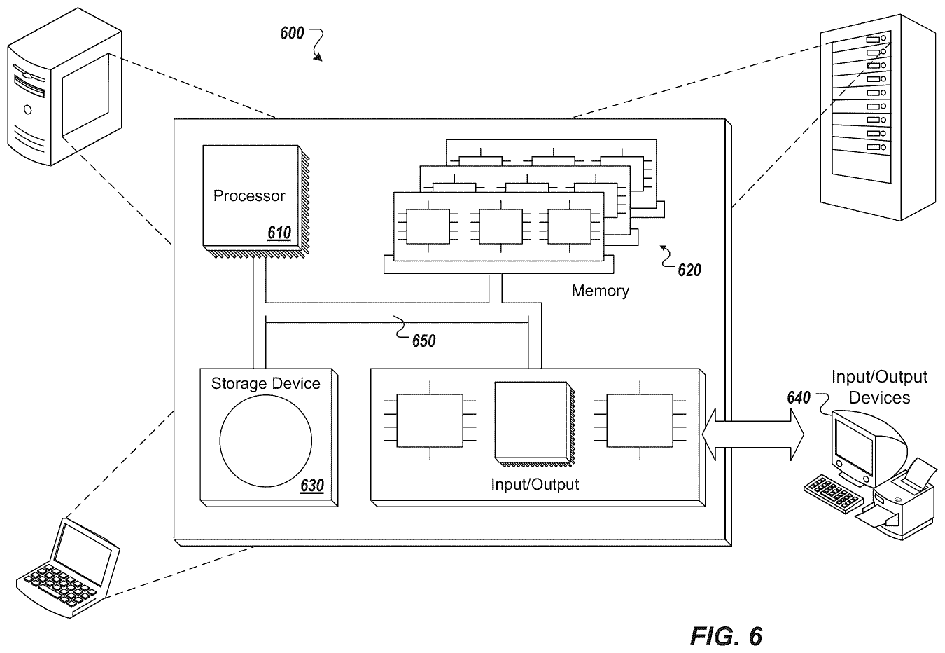

Referring now to FIG. 6, a schematic diagram of an example computing system 600 is provided. The system 600 can be used for the operations described in association with the implementations described herein. For example, the system 600 may be included in any or all of the server components discussed herein. The system 600 includes a processor 610, a memory 620, a storage device 630, and an input/output device 640. The components 610, 620, 630, 640 are interconnected using a system bus 650. The processor 610 is capable of processing instructions for execution within the system 600. In some implementations, the processor 610 is a single-threaded processor. In some implementations, the processor 610 is a multi-threaded processor. The processor 610 is capable of processing instructions stored in the memory 620 or on the storage device 630 to display graphical information for a user interface on the input/output device 640.

The memory 620 stores information within the system 600. In some implementations, the memory 620 is a computer-readable medium. In some implementations, the memory 620 is a volatile memory unit. In some implementations, the memory 620 is a non-volatile memory unit. The storage device 630 is capable of providing mass storage for the system 600. In some implementations, the storage device 630 is a computer-readable medium. In some implementations, the storage device 630 may be a floppy disk device, a hard disk device, an optical disk device, or a tape device. The input/output device 640 provides input/output operations for the system 600. In some implementations, the input/output device 640 includes a keyboard and/or pointing device. In some implementations, the input/output device 640 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for determining duplicate crash reports from a set of crash reports generated in response to respective crashes of a software system, the method being executed by one or more processors and comprising:
receiving a set of crash reports, each crash report provided as a computer-readable file;
determining a set of trace vectors by processing a set of stack traces through a first deep learning (DL) model, each trace vector in the set of trace vectors comprising a multi-dimensional vector representation of a stack trace of a respective crash report provided from the set of stack traces;
generating a set of feature vectors by processing the set of trace vectors through a second DL model, each feature vector comprising a multi-dimensional vector representation of a stack trace of a respective crash report; and
clustering each crash report in the set of crash reports into a group of a set of groups based on comparing feature vectors of respective crash reports, each group representative of a root cause resulting in respective crashes of the software system represented in one or more crash reports.

2. The method of claim 1, further comprising pre-processing each crash report in the set of crash report to extract a respective stack trace that is included in the set of stack traces.

3. The method of claim 1, wherein processing the set of stack traces through the first DL model comprises, for each stack trace and for each frame in a set of frames of the stack trace:
segmenting a frame into a set of sub-frames;
determining a sub-frame representation for each sub-frame in the set of sub-frames; and
combining the sub-frame representations to provide a trace vector for the frame.

4. The method of claim 1, wherein generating the set of feature vectors by processing the set of trace vectors through the second DL model comprises providing each trace vector as input to the second DL model and receiving a respective feature vector as output of the second DL model.

5. The method of claim 1, wherein the second DL model is trained using a circle loss to minimize distances between anchor samples and positive samples and maximize distances between the anchor samples and negative samples, and a softmax loss based on predictions of a large-margin softmax layer.

6. The method of claim 1, wherein the second DL model comprises bidirectional long short-term memory (Bi-LSTM) layers, two fully-connected layers (linear), and a rectified linear unit (ReLU) layer.

7. The method of claim 1, wherein at least one group is used to debug the software system with respect to a respective root cause.

8. A non-transitory computer-readable storage medium coupled to one or more processors and having instructions stored thereon which, when executed by the one or more processors, cause the one or more processors to perform operations determining duplicate crash reports from a set of crash reports generated in response to respective crashes of a software system, the operations comprising:
receiving a set of crash reports, each crash report provided as a computer-readable file;
determining a set of trace vectors by processing a set of stack traces through a first deep learning (DL) model, each trace vector in the set of trace vectors comprising a multi-dimensional vector representation of a stack trace of a respective crash report provided from the set of stack traces;
generating a set of feature vectors by processing the set of trace vectors through a second DL model, each feature vector comprising a multi-dimensional vector representation of a stack trace of a respective crash report; and
clustering each crash report in the set of crash reports into a group of a set of groups based on comparing feature vectors of respective crash reports, each group representative of a root cause resulting in respective crashes of the software system represented in one or more crash reports.

9. The non-transitory computer-readable storage medium of claim 8, wherein operations further comprise pre-processing each crash report in the set of crash report to extract a respective stack trace that is included in the set of stack traces.

10. The non-transitory computer-readable storage medium of claim 8, wherein processing the set of stack traces through the first DL model comprises, for each stack trace and for each frame in a set of frames of the stack trace:
segmenting a frame into a set of sub-frames;
determining a sub-frame representation for each sub-frame in the set of sub-frames; and
combining the sub-frame representations to provide a trace vector for the frame.

11. The non-transitory computer-readable storage medium of claim 8, wherein generating the set of feature vectors by processing the set of trace vectors through the second DL model comprises providing each trace vector as input to the second DL model and receiving a respective feature vector as output of the second DL model.

12. The non-transitory computer-readable storage medium of claim 8, wherein the second DL model is trained using a circle loss to minimize distances between anchor samples and positive samples and maximize distances between the anchor samples and negative samples, and a softmax loss based on predictions of a large-margin softmax layer.

13. The non-transitory computer-readable storage medium of claim 8, wherein the second DL model comprises bidirectional long short-term memory (Bi-LSTM) layers, two fully-connected layers (linear), and a rectified linear unit (ReLU) layer.

14. The non-transitory computer-readable storage medium of claim 8, wherein at least one group is used to debug the software system with respect to a respective root cause.

15. A system, comprising:
a computing device; and
a computer-readable storage device coupled to the computing device and having instructions stored thereon which, when executed by the computing device, cause the computing device to perform operations for natural language explanations for determining duplicate crash reports from a set of crash reports generated in response to respective crashes of a software system, the operations comprising:
receiving a set of crash reports, each crash report provided as a computer-readable file;
determining a set of trace vectors by processing a set of stack traces through a first deep learning (DL) model, each trace vector in the set of trace vectors comprising a multi-dimensional vector representation of a stack trace of a respective crash report provided from the set of stack traces;
generating a set of feature vectors by processing the set of trace vectors through a second DL model, each feature vector comprising a multi-dimensional vector representation of a stack trace of a respective crash report; and
clustering each crash report in the set of crash reports into a group of a set of groups based on comparing feature vectors of respective crash reports, each group representative of a root cause resulting in respective crashes of the software system represented in one or more crash reports.

16. The system of claim 15, wherein operations further comprise pre-processing each crash report in the set of crash report to extract a respective stack trace that is included in the set of stack traces.

17. The system of claim 15, wherein processing the set of stack traces through the first DL model comprises, for each stack trace and for each frame in a set of frames of the stack trace:
segmenting a frame into a set of sub-frames;
determining a sub-frame representation for each sub-frame in the set of sub-frames; and
combining the sub-frame representations to provide a trace vector for the frame.

18. The system of claim 15, wherein generating the set of feature vectors by processing the set of trace vectors through the second DL model comprises providing each trace vector as input to the second DL model and receiving a respective feature vector as output of the second DL model.

19. The system of claim 15, wherein the second DL model is trained using a circle loss to minimize distances between anchor samples and positive samples and maximize distances between the anchor samples and negative samples, and a softmax loss based on predictions of a large-margin softmax layer.

20. The system of claim 15, wherein the second DL model comprises bidirectional long short-term memory (Bi-LSTM) layers, two fully-connected layers (linear), and a rectified linear unit (ReLU) layer.
